(19) United States
(12) Patent Application Publication
(10) Pub. No.: US 2005/0203903 A1
(43) Pub. Date: Sep. 15, 2005

(54) System and method for locking and isolation in a storage platform

(76) Inventors: Rajeev B. Rajan, Kirkland, WA (US); Balan Sethu Raman, Redmond, WA (US)

Correspondence Address: WOODCOCK WASHBURN LLP, ONE LIBERTY PLACE - 46TH FLOOR, PHILADELPHIA, PA, 19103, US

(21) Appl. No.: 10/797,238

(22) Filed: Mar. 10, 2004

(51) Int. Cl. G06F 17/30

(52) U.S. Cl. 707/8

(57) ABSTRACT

The sharing model for file system operations is unified with the transaction and locking model of query language statements to provide an overall framework for locking and isolation in a storage platform. Additionally, transactional support is provided for file system operations so that they may be executed in the context of a transaction. Accordingly, a single transaction may include a single file system statement, a single query language statement, multiple file system statements, multiple query language statements, and a combination of file system and query language statements. Furthermore, support is provided for non-transacted file systems statements so that file system statements need not necessarily be executed in the context of a transaction.

### FIELD OF THE INVENTION

The present invention relates to the field of data retrieval and manipulation, and, more specifically, to locking and isolation in a storage platform.

### BACKGROUND OF THE INVENTION

A recent development in the computing field is that a computer operating system may be employed with a storage platform that is built on a relational engine. Such a storage platform may be, for example, MICROSOFT WINDOWS FILE SYSTEM™ (“WinFS”) from Microsoft Corp. of Redmond, Wash. WinFS is built on SQL SERVER™ from the aforementioned Microsoft Corp.

The data model of the WinFS platform defines units of data storage in terms of items, item extensions, and relationships. An item is the fundamental unit of storage information. The data model provides a mechanism for declaring items and item extensions and for establishing relationships between items. Items are the units that can be stored and retrieved using operations such as copy, delete, move, open, and so forth. Items are intended to represent real-world and readily-understandable units of data like Contacts, People, Services, Locations, Documents (of all various sorts), and so on. Item extensions are a way to extend the definition of an existing item, and relationships are a defined link between items.

In WinFS, different item types are defined for storing information. For example, item types are defined for Contacts, People, Locations, Documents, etc. Each item type is described by a schema that defines the properties and characteristics of a given item. For example, a “Location ” Item may be defined as having properties such as EAddresses, MetropolitanRegion, Neighborhood, and PostalAddresses. Once a schema is defined for a given item type, a corresponding user defined type (UDT) is created in the data store. Each instance of an Item type stored in the data store has a unique identifier (e.g., Item_ID) associated with it; in one embodiment, each item identifier is a globally unique identifier (GUID). As with any instance of a UDT in SQL SERVER, instances of WinFS items are ultimately stored in tables of the database store in a separate UDT column.

One of the building blocks of WinFS is that it incorporates filestream technology from SQL Server. A filestream is a column of a relational data table in which data for each cell of the column is stored in a file that is separate from the file that stores the other columns of the table. An important feature of WinFS is that each field of a WinFS item may be designated as a filestream field. Filestream technology is particularly advantageous for items that include fields with large amounts of data. For example, a Person item may have a “photo” field that includes a digital photograph of a corresponding person. The photo field may include large amounts of data that is not suitable for storage in a data table.

Another important feature of WinFS is that it enables “out of band” access to filestream fields so that they can be accessed via traditional file system calls (open, read/write, close, etc.) without using the underlying query language of the database store. A file system application program interface (API) for submitting traditional file systems calls may be, for example Win32™ from the aforementioned Microsoft Corp, while an underlying query language of the database store may be, for example, transact structured query language (T-SQL). Because WinFS enables out of band access to filestream fields, items that include such filestream fields may be manipulated through two different channels: T-SQL and Win32.

One difference with respect to T-SQL and Win 32 is that T-SQL has a well defined transactional and locking model, while Win 32 does not. The term “transaction” as used herein, refers to The transaction model in T-SQL is built around the concept of a statement. A T-SQL statement represents an operation against the data store, e.g., a “SELECT” or “UPDATE” statement. A T-SQL statement may be included as part of either a single statement transaction or a multi-statement transaction. In a single statement transaction, a single executed T-SQL statement creates a transaction on the data store which commits if the statement executes successfully. The transaction lifetime is scoped by the statement. In a multi-statement transaction, an application issues “Begin Transaction” and “Commit Transaction” T-SQL statements to explicitly begin and commit (or abort) transactions against the data store. All of the statements within the begin and commit bracket are executed as part of the same multi-statement transaction on the data store.

T-SQL has well-defined semantics for transaction locking. In general, a “SELECT” statement will acquire a read lock on a row, while an “UPDATE” statement will acquire a write lock on a row. Write locks are held until a transaction commits or aborts, while read locks may be released earlier. If a transaction has a write lock on a row, then other transactions are blocked from obtaining read and/or write access to the row. If a transaction attempts to obtain read and/or write access to a row on which another transaction has already acquired write lock, then a conflict occurs. Standard conflict resolution methods may be employed to resolve the conflict.

Rather than using the concept of a statement, Win32 uses traditional file system sharing modes to define isolation between operations (open, read/write, close). The file share read flag enables read sharing, meaning that an open of a file can share reading with another open against the same file. The file share write flag enables write sharing, meaning that an open of a file can share writing with another open against the same file. Additionally, both the file share read flag and the file share write flag may be set to enable both read and write sharing. Furthermore, neither file share flag may be set to deny sharing. Importantly, conventional Win32 API's and other conventional file system API's do not enable operations to be executed in the context of a transaction.

Thus, there is a need in the art for systems and methods for locking and isolation in a storage platform that unify the query language transaction and locking model with the file system sharing model. The unification of the transaction models will provide an overall transaction model for manipulating items that contain filestream fields in storage platforms such as WinFS. It is further desired that the overall framework enable file system operations to be executed in the context of a transaction.

### SUMMARY OF THE INVENTION

The present invention is directed to systems and methods for locking and isolation in a storage platform. According to the invention, the sharing model for file system operations is unified with the transaction and locking model for query language statements to provide an overall framework for locking and isolation of filestreams in a storage platform. Additionally, transactional support is provided for file system operations so that they may be executed in the context of a transaction. Accordingly, a single transaction may include a single file system statement, a single query language statement, multiple file system statements, multiple query language statements, and a combination of file system and query language statements. Furthermore, support is provided for non-transacted file system operations so that file system operations need not necessarily be executed in the context of a transaction.

According to an aspect of the invention, a file system statement may include a call to open an item, a read or write operation, and a call to close the item. A file system statement may acquire isolation on a row of a data table that includes a user defined type (UDT) corresponding to the item. Transacted write statements acquire an exclusive lock on a row for the lifetime of the transaction. Transacted read statements acquire a read committed view of a row. File system sharing modes may be used to define isolation between transactions and between statements within a transaction. Furthermore, non-transacted statements may also acquire isolation based on sharing modes.

According to another aspect of the invention, a number of query language statements and/or file system statements may be received at the storage platform. The statements may be associated with a transaction. It may be determined if starting the transaction will result in a conflict. If so, then the conflict may be resolved according to standard conflict resolution techniques such as, for example, blocking. If there are no conflicts, then the transaction may be started by acquiring the appropriate read and/or write locks for the query language statements and/or file system statements within the transaction.

Additional features and advantages of the invention will be made apparent from the following detailed description of illustrative embodiments that proceeds with reference to the accompanying drawings.

### BRIEF DESCRIPTION OF THE DRAWINGS

The illustrative embodiments will be better understood after reading the following detailed description with reference to the appended drawings, in which:

FIG. 1 is an exemplary database table including data for item instances in accordance with the present invention;

FIG. 2 is a block diagram of an exemplary storage platform environment in accordance with the present invention;

FIG. 3 is a flowchart of an exemplary method for executing a file system statement in the context of a transaction in accordance with the present invention

FIG. 4 is a flowchart of an exemplary method for locking and isolation of a non-transacted read file system statement in accordance with the present invention;

FIG. 5 is a flowchart of an exemplary method for locking and isolation of a non-transacted write file system statement in accordance with the present invention;

FIG. 6 is a block diagram representing an exemplary network environment having a variety of computing devices in which the present invention may be implemented; and

FIG. 7 is a block diagram representing an exemplary computing device in which the present invention may be implemented.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

As stated above, the present invention is directed to systems and methods for locking and isolation in a storage platform such as the aforementioned Win FS. The present invention enables file system operations such as the aforementioned Win 32 operations to be executed in the context of a transaction. Additionally, the present invention unifies the sharing model for file system operations with the transaction and locking model for query languages such as the aforementioned T-SQL, thereby providing an overall model for manipulating items that contain filestream fields in a storage platform.

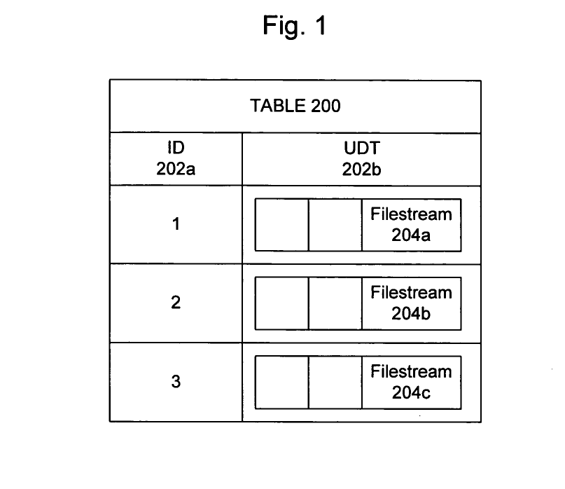

Referring now to FIG. 1, instances of storage platform items may be stored in a relational database table such as exemplary table 200. Table 200 includes two columns: ID column 202a and user defined type (UDT) column 202b. Each ID in column 202a provides a unique identifier for a corresponding UDT. Each UDT in column 202b corresponds to an instance of an item type. For example, each UDT in column 202b may correspond to a particular person associated with a Person item type. Fields 204a-c of UDT's 1-3, respectively, are designated as filestream fields, meaning that data for the field is stored in a file that is separate from Table 200. Filestream fields 204a-c are advantageous for storing fields that include large amounts of data such as digital photographs. For example a Person item may have a corresponding “photo” field that is a filestream field including a digital photograph of the person. The present invention enables locking and isolation of rows such as each of rows 1-3 of Table 200, as discussed in detail below.

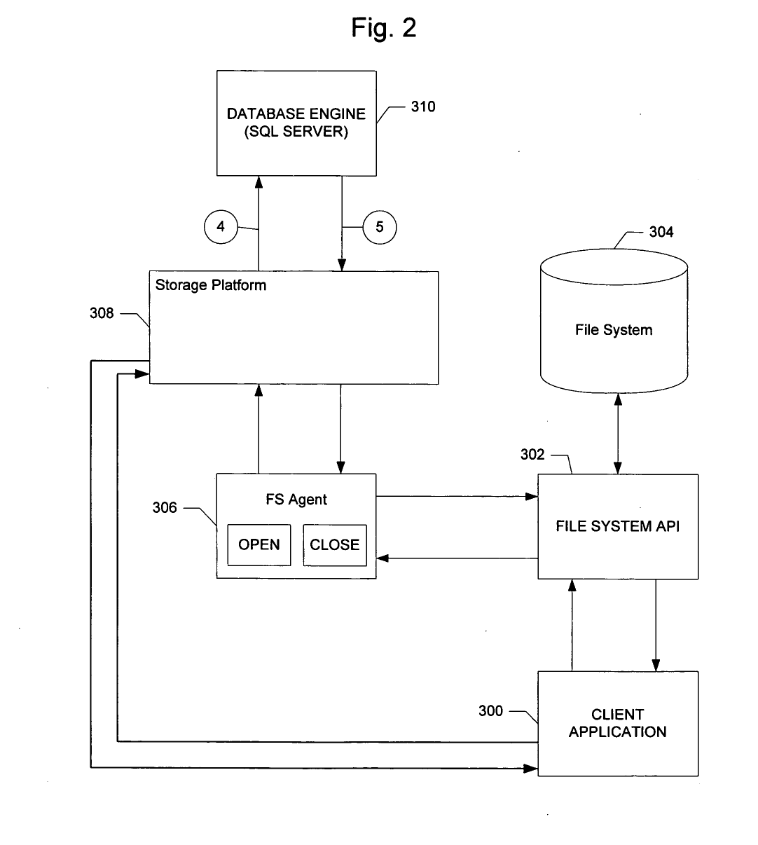

An exemplary storage platform environment is shown in FIG. 2. As set forth above, client application 300 may manipulate items in data store 310 directly through storage platform 308 or via “out of band” access through file system API 302. If client application 300 manipulates items directly through storage platform 308, such manipulation may be performed using a query language such as T-SQL. If, on the other hand, client application 300 manipulates items via “out of band” access through file system API 302, such manipulation may be performed using a file system API such as Win33. “Out of band” access is only available for items that include filestream fields.

Client application 300 may access storage platform 308 directly by using storage platform methods to initiate a query on data store 310. Continuing with the Person item type example, client application 300 may use a “FindAll” method of storage platform 308 to initiate a query for all instances of the Person type in which the value in a “Birthday” field of the type is greater than a particular date (e.g., Dec. 31, 1999). Storage platform 308 then translates the “FindALL” operation into a query in T-SQL or another query language and submits it to the underlying data store 310. The data store 310 then executes the query against the corresponding instances of the Person UDT and returns the stored values for each matching instance of the Person UDT. Storage platform 308 then wraps the Person UDT objects and returns them to the application as items of the Person type.

In addition to enabling direct access to items as set forth above, storage platform 308 enables “out of band” access to Filestream fields in the items via file system API 302. In the exemplary environment of FIG. 2, client application 300 initiates out of band access by, for example, calling the CreateFile interface of the storage platform 308 and passing a path name to the storage platform 308 that identifies the requested data based on the identity of the corresponding field in the instance of a persisted item (UDT). When the File System API 302 receives a CreateFile command from client application 300 that includes the storage platform path name, File System API 302 recognizes it as such and forwards it to the FS Agent 306. The FS Agent 306 then issues an “OPEN” call to the storage platform 308, passing the storage platform path name of the item field. Storage platform 308 then identifies the item and field from the storage platform path name and then passes this information to the database engine 310. Storage platform 308 may pass a database engine function that returns the file system pathname for a filestream field of a UDT object that has been stored separately from the database store in the manner described above.

The database engine 310 responds to the request by performing a table look-up in the table 200 in which the UDT object that is the subject of the request is stored. The database engine 310 positions to the correct row of the table 200 and then to the serialized fragments of the UDT object within that row. For the filestream field in question, the database engine 310 extracts from its corresponding fragment the real file system path to the file in which the data for that field is stored. The database engine 310 sends the real path back to the storage platform 308. Storage platform 308 then passes the file system path back to the FS Agent 106, which, in turn, calls the File System API 302 to open the file, passing the real file system path in the request. File System API 302 then obtains a handle to the file and passes it back to client application 300 as it normally would when a CreateFile call is made to the File System API 302.

At this point, the client application 300 can read and write to the file via normal File System API calls (e.g., Win33 API File I/O calls). When the client application 300 is finished with the file, it issues a CLOSE call to the File System API. This call is again intercepted by the FS Agent 306. FS Agent 306 issues a “CLOSE” call to the storage platform 308 to request that the file be closed. The storage platform 308 models this operation as an update to the persisted item, performing any associated change tracking and other functions associated with the update. The database engine 310 then does its own update processing on the persisted UDT object. Once this processing is complete, control returns to the FS Agent 306, which calls the File System API 302 to perform its normal file close operation on behalf of the client application 300.

Thus, in the environment described above, storage platform 308 enables direct access to a filestream field using a query language such as T-SQL or “out of band” access using a file system API such as Win32. As stated above, there are a number of differences between the query language transaction and locking model and the file system sharing model. One such difference is that the file system does not have the notion of a statement as in the query language. Rather, the file system generates operations such as, for example, open, read, write, and close. The present invention enables an open to be done in the context of a transaction. The file opened may be associated with the transaction context provided during the open. Subsequent reads and/or writes occur in the context of the transaction. As with transactions in a query language, there can be only one transacted writer to a file at any given moment. Furthermore, transacted readers get a read committed view of the file, meaning that they view the file in its committed state at the time of open.

Non-transacted readers and writers may obtain isolation based on the sharing modes specified. When a file is opened, the intention of the open may be specified. The file may be opened for one of the following three intents: open for read intent, open for write intent, or open for both read and write intent. Additionally, a desired isolation model may be specified using the sharing modes: file share read, file share write, both file share read and file share write, or neither file share read or file share write. For file system operations, an open is failed rather than blocked if it is denied access to a file based on a sharing conflict. The open may be retried at a later time in the hope that the sharing conflict will not recur.

The sharing modes may provide isolation at two levels, namely between transactions and between opens within a transaction. All non-transacted opens may operate as if they were all within a single global transaction that is always active and auto-commits for every non-transacted write. Non-transacted reads do not get a read committed view of a corresponding file and are provided only the isolation requested with the sharing modes.

In the storage platform 308, the unit of isolation may be the item, an extension associated with the item, or a relationship associated with the item. In each of these three cases, the underlying representation is an instance of a UDT in an appropriate table, and the unit of isolation corresponds to a row in the table. This maps to the query language locking model, in which the appropriate locks are obtained on a per row basis. Thus, the granularity of locking in the storage platform 308 maps directly to the granularity of a row in the query language.

As set forth above, in addition to providing transactional support for file system operations, the present invention is directed to unifying the models for file system operations and query language statements. Unlike file system statements, which are only processed for out of band access to filestream items, query language statements may be executed upon both filestream and non-filestream items. To unify the transactional model of the query language with the sharing model of the file system, it is necessary to define that concept of a file system statement. Such a file system statement may include an open operation, either a read or a write operation, and a close operation. Thus, a file system statement that includes open, read, and close operations is semantically equivalent to a SELECT filestream statement in the query language, while a file system statement that includes open, write, and close operations is semantically equivalent to an UPDATE filestream statement in the query language.

As with query language statements, file system statements may occur in the context of a multi-statement transaction or a single statement transaction, in which the transaction is present during the processing of the statement. Thus, a transaction in accordance with the present invention may include either a single query language statement, a single file system statement, multiple query language statements, multiple file system statements, or a combination of query language and file system statements.

In the case of a single query language statement, fields in an item are updated and an updategram is sent to the server. All values in the item may be inlined including Filestream values. As part of executing the updategram, a transaction may be created and committed instantaneously on the server.

In the case of a single file system statement, a transaction is created as part of the open. A read or write then occurs within the context of the transaction. The transaction is then committed as part of the close. The storage platform 308 may create and manage the lifetime of the transaction across the <open, write, close> boundary.

In the case of multiple query language statements, a transaction is started on the server, item fields are updated, and one or more updategrams are sent to the server. The transaction is then committed on the server.

In the case of multiple file system statements, a transaction is started on the server, and the file system statements are executed in the context of the transaction. The transaction is then committed on the server.

In the case of a combination of query language and file system statements, a transaction is started on the server, and updategrams may then be issued that modify non-filestream fields in an item. File system statements may then be executed in the context of the transaction. The transaction is then committed on the server.

A transaction context may be specified for file system operations to obtain the appropriate locks on corresponding rows. If an open is for read, then the transaction will obtain a read lock on the row containing the Filestream. If an open is for write, then the transaction will obtain a write lock on the row containing the Filestream. FsAgent 306 may obtain row locks on behalf of a transaction, and locks may be released based on the transaction isolation level and may be tied to the transaction lifetime.

To emulate the query language isolation model, an exclusive open may be obtained for writers, while a shared open may be obtained for readers. The exclusive and shared opens correspond to an exclusive row level lock and a shared row level lock, respectively, in the query language model. Thus, certain sharing mode flags may contradict with this model and may not be honored.

For example, the file share write flag contradicts with this model because it enables two opens to share writing to the same file. Thus, the file share write flag may be disallowed and not honored. The file share write may, for example, be silently remapped or rejected with an appropriate error code. Accordingly, if a transaction includes multiple file system write statements, then the write operations may be serialized. Serialization within a transaction is consistent with query language semantics in which multiple concurrent updates are not allowed in the context of the same transaction. Furthermore, if two non-transacted file system statements attempt to execute simultaneously, then they may also be serialized. Serialization of non-transacted statements is consistent with query langue statement semantics in which two UPDATE statements cannot execute concurrently. Additionally, an open for write in the context of a transaction must specify the file share read. If it does not, the open may be failed with an invalid operation error code. This enforces the query language semantic that an UPDATE does not prevent a SELECT in the context of the same transaction.

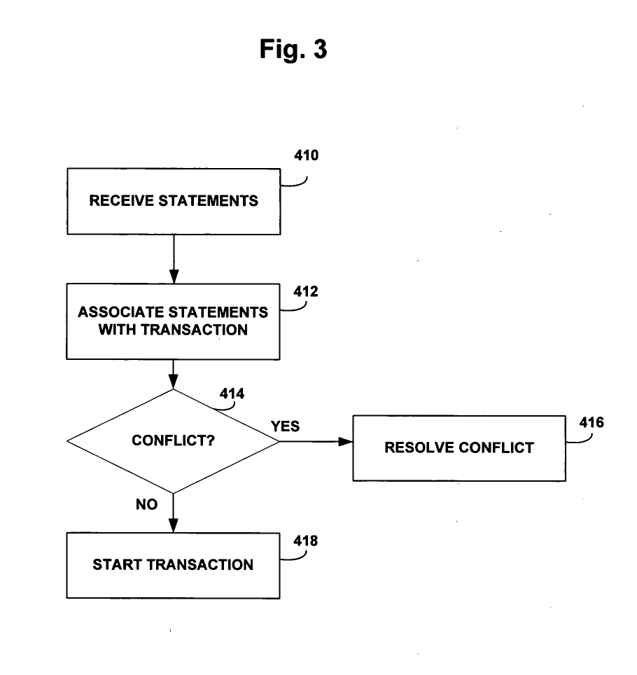

A flowchart of an exemplary method for executing a file system statement in the context of a transaction in accordance with the present invention is shown in FIG. 3. At act 410, storage platform 308 receives statements from client application 300 to be executed upon items stored in data store 310. Such statements may be query language statements received from client application 300 or out of band file system statements received from client application 300 via file system API 802 and FSAgent 804. Query language statements may be executed upon both filestream and non-filestream items, while file system statements may only be executed upon filestream items.

As set forth above, a query language statement may include, for example, either a SELECT statement or an UPDATE statement. A query language statement may be part of either a single or a multiple statement transaction. If the query language statement is part of a multiple statement transaction, then it is bracketed by begin transaction and commit transaction commands.

A file system statement may include an open operation, either a read operation or a write operation, and a close operation. Each file system statement may be submitted in the context of the transaction. At act 412, each statement received at act 410 is associated with the transaction.

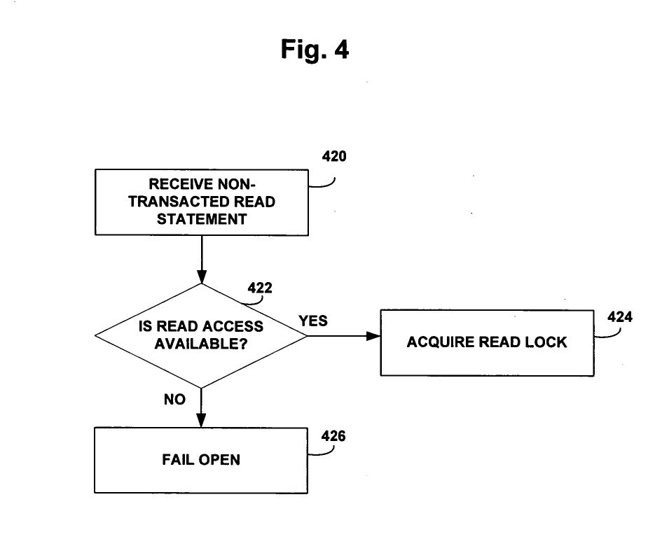

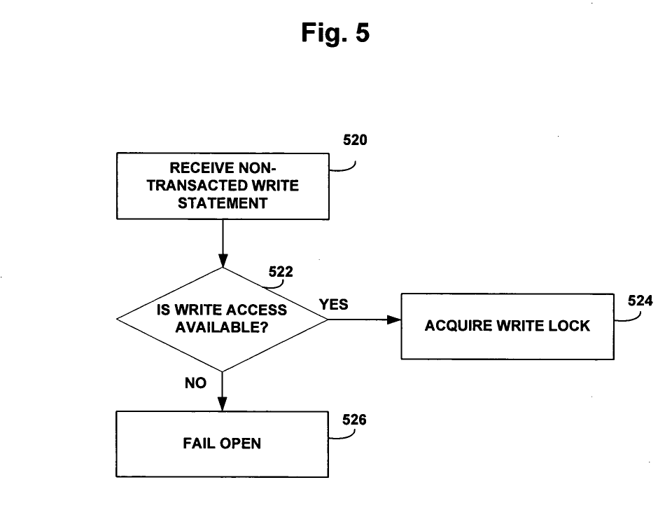

As should be appreciated, file system statements need not necessarily be submitted in the context of a transaction. Locking and isolation for such non-transacted file system statements is discussed in detail below with reference to FIGS. 4 and 5.

At act 414, it is determined whether starting the transaction will result in a conflict. For example, if any statements within the transaction correspond to a row upon which another transaction has already acquired a write lock, then a conflict will occur.

If, at act 414, it is determined that a conflict will occur, then, at act 416, the conflict is resolved. The conflict may be resolved according to standard conflict resolution practices. Generally, even if only one conflict is detected, then the entire transaction may be rolled back.

At act 418, the transaction is started. The transaction is started by acquiring read locks and write locks on the appropriate rows. As set forth previously, read locks are acquired on rows corresponding to read operations and to SELECT statements. Read locks corresponding to read operations acquire a read committed view of the row. The read lock is a shared row lock.

Write locks are acquired on rows corresponding to write operations and to UPDATE statements. The write lock is an exclusive lock that is acquired for the lifetime of the transaction. The write lock will prevent another transaction from accessing (through either read access or write access) a corresponding row while the transaction is being processed. The write lock will also prevent a non-transacted file system statement from accessing (through either read access or write access) a corresponding row while the transaction is being processed. The write lock does not, however, prevent other statements within the transaction from reading a corresponding row.

A flowchart of an exemplary method for locking and isolation of a non-transacted file system read statement in accordance with the present invention is shown in FIG. 4. At act 420, storage platform 308 receives a non-transacted file system read statement from client application 300 to be executed upon an item stored in data store 310. As set forth above, a file system read statement includes an open operation, a read operation, and a close operation.

At act 422, it is determined whether read access is available for a row of a data table corresponding to the item. The row may include a user defined type corresponding to the item.

If, at act 422, it is determined that read access is available, then, at act 424, a read lock is acquired on the row. The read lock may provide a read committed view of the row. If, at act 422, it is determined that read access is not available, then, at act 426, the open is failed.

A flowchart of an exemplary method for locking and isolation of a non-transacted file system write statement in accordance with the present invention is shown in FIG. 5. At act 520, storage platform 308 receives a non-transacted file system write statement from client application 300 to be executed upon an item stored in data store 310. As set forth above, a file system write statement includes an open operation, a write operation, and a close operation.

At act 522, it is determined whether write access is available for a row of a data table corresponding to the item. The row may include a user defined type corresponding to the item. Write access may be denied if, for example, a transaction or another non-transacted statement already has a write lock on the row.

If, at act 522, it is determined that write access is available, then, at act 524, a write lock is acquired on the row. The write lock may prevent a transaction or another non-transacted statement from acquiring a write lock on the row while the statement is being processed. If, at act 522, it is determined that read access is not available, then, at act 526, the open is failed.

As is apparent from the above, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language.

The present invention may also be embodied in the form of program code that is transmitted over some transmission medium, such as over electrical wiring or cabling, through fiber optics, over a network, including a local area network, a wide area network, the Internet or an intranet, or via any other form of transmission, wherein, when the program code is received and loaded into and executed by a machine, such as a computer, the machine becomes an apparatus for practicing the invention.

When implemented on a general-purpose processor, the program code may combine with the processor to provide a unique apparatus that operates analogously to specific logic circuits.

Moreover, the invention can be implemented in connection with any computer or other client or server device, which can be deployed as part of a computer network, or in a distributed computing environment. In this regard, the present invention pertains to any computer system or environment having any number of memory or storage units, and any number of applications and processes occurring across any number of storage units or volumes, which may be used in connection with processes for persisting objects in a database store in accordance with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by exchange between computing devices and systems. These resources and services include, but are not limited to, the exchange of information, cache storage, and disk storage for files. Distributed computing takes advantage of network connectivity, allowing clients to leverage their collective power to benefit the entire enterprise. In this regard, a variety of devices may have applications, objects or resources that may implicate processing performed in connection with the object persistence methods of the present invention.

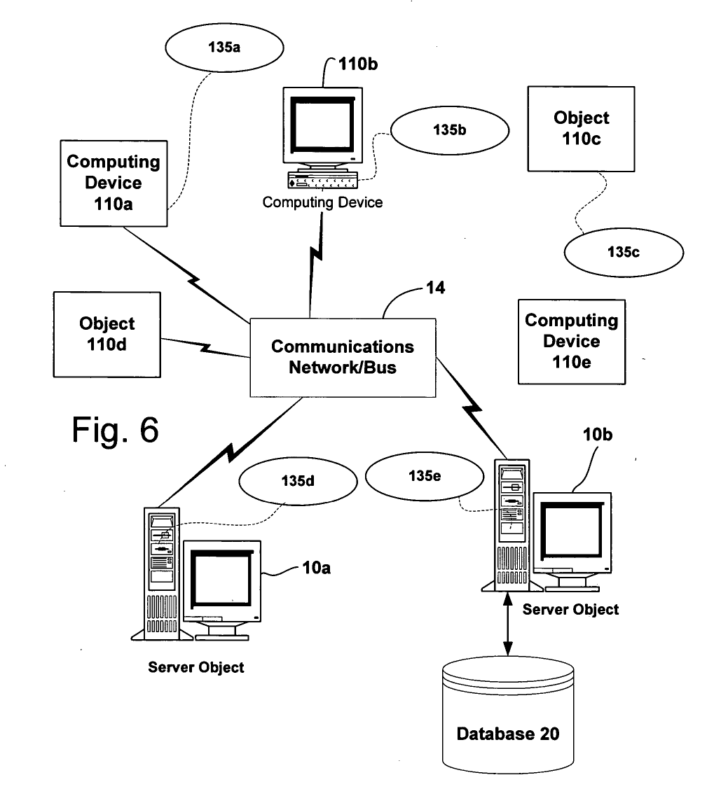

FIG. 6 provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, personal computers, etc. Each object can communicate with another object by way of the communications network 14. This network may itself comprise other computing objects and computing devices that provide services to the system of FIG. 6, and may itself represent multiple interconnected networks. In accordance with an aspect of the invention, each object 10a, 10b, etc. or 110a, 110b, 110c, etc. may contain an application that might make use of an API, or other object, software, firmware and/or hardware, to request use of the processes used to implement the object persistence methods of the present invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks. Any of the infrastructures may be used for exemplary communications made incident to the present invention.

The Internet commonly refers to the collection of networks and gateways that utilize the TCP/IP suite of protocols, which are well-known in the art of computer networking. TCP/IP is an acronym for “Transmission Control Protocol/Internet Protocol.” The Internet can be described as a system of geographically distributed remote computer networks interconnected by computers executing networking protocols that allow users to interact and share information over the network(s). Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 6, computers 110a, 110b, etc. can be thought of as clients and computer 10a, 10b, etc. can be thought of as servers, although any computer could be considered a client, a server, or both, depending on the circumstances. Any of these computing devices may be processing data in a manner that implicates the object persistence techniques of the invention.

A server is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the persistence mechanism of the invention may be distributed across multiple computing devices.

Client(s) and server(s) may communicate with one another utilizing the functionality provided by a protocol layer. For example, Hypertext Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over any available communications medium.

Thus, FIG. 6 illustrates an exemplary networked or distributed environment, with a server in communication with client computers via a network/bus, in which the present invention may be employed. The network/bus 14 may be a LAN, WAN, intranet, the Internet, or some other network medium, with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to maintain a persisted object.

In a network environment in which the communications network/bus 14 is the Internet, for example, the servers 10a, 10b, etc. can be servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment.

Communications may be wired or wireless, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 10e, etc. and server computer 10a, 10b, etc. may be equipped with various application program modules or objects 135 and with connections or access to various types of storage elements or objects, across which files or data streams may be stored or to which portion(s) of files or data streams may be downloaded, transmitted or migrated. Any computer 10a, 10b, 110a, 110b, etc. may be responsible for the maintenance and updating of a database, memory, or other storage element 20 for storing data processed according to the invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other like devices, and databases 20.

FIG. 6 and the following discussion are intended to provide a brief general description of a suitable computing device in connection with which the invention may be implemented. For example, any of the client and server computers or devices illustrated in FIG. 6 may take this form. It should be understood, however, that handheld, portable and other computing devices and computing objects of all kinds are contemplated for use in connection with the present invention, i.e., anywhere from which data may be generated, processed, received and/or transmitted in a computing environment. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved or transmitted to another computer is a desirable, or suitable, environment for operation of the object persistence methods of the invention.

Although not required, the invention can be implemented via an operating system, for use by a developer of services for a device or object, and/or included within application or server software that operates in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like.

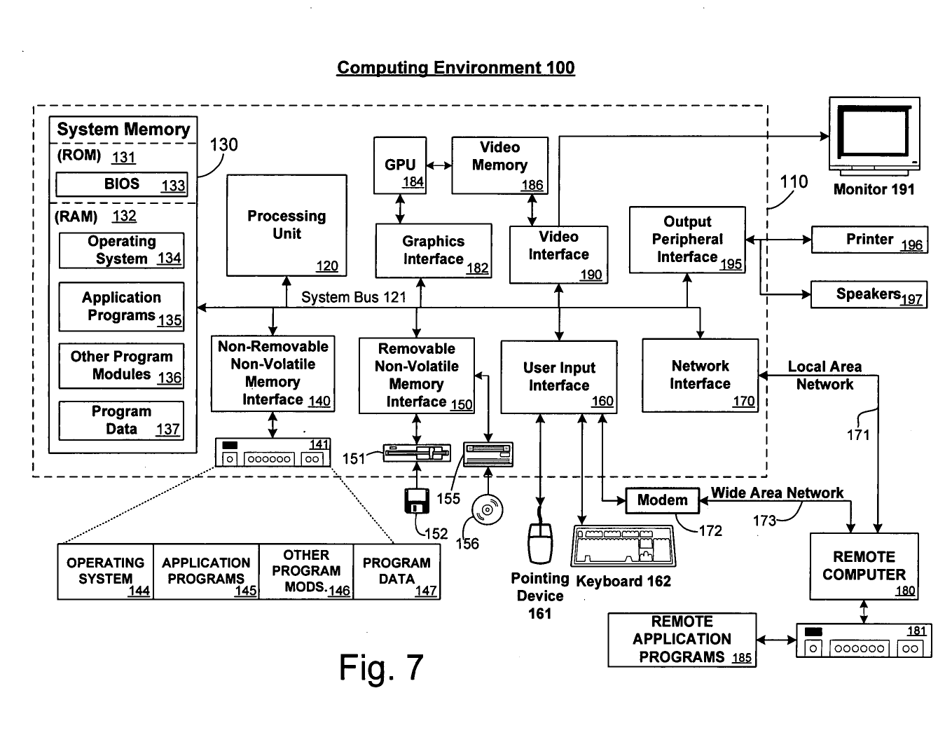

FIG. 7 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 7, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 7 illustrates operating system 134, application programs 135, other program modules 136, and program data 137.

The computer 110 may also include other removable/non-removable, volatile/nonvolatile computer storage media. By way of example only, FIG. 8 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 7 provide storage of computer readable instructions, data structures, program modules and other data for the computer 110. In FIG. 7, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 7. The logical connections depicted in FIG. 7 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 7 illustrates remote application programs 185 as residing on memory device 181. It will be appreciated that the network connections shown are exemplary and other means of establishing a communications link between the computers may be used.

### CONCLUSION

Thus, systems and methods for locking and isolation in a storage platform have been disclosed. The sharing model for file system operations is unified with the transaction and locking model for query language statements to provide an overall framework for locking and isolation in a storage platform. Additionally, transactional support is provided for file system operations so that they may be executed in the context of a transaction. Accordingly, a single transaction may include a single file system statement, a single query language statement, multiple file system statements, multiple query language statements, and a combination of file system and query language statements. Furthermore, support is provided for non-transacted file systems statements so that file system statements need not necessarily be executed in the context of a transaction.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather should be construed in breadth and scope in accordance with the appended claims.

1. A method for executing a file system statement in the context of a transaction, the file system statement including a call to open an item, one of a call to read from the item and a call to write to the item, and a call to close the item, the method comprising:
associating the file system statement with the transaction; and
starting the transaction by acquiring one of a read lock and a write lock on a data table row corresponding to the item.

2. The method of claim 1, comprising starting the transaction by acquiring one of a read lock and a write lock on a data table row that includes a user defined type corresponding to the item

3. The method of claim 1, further comprising associating a second statement with the transaction.

4. The method of claim 3, comprising associating the second statement with the transaction, the second statement being another file system statement.

5. The method of claim 3, comprising associating the second statement with the transaction, the second statement being a transactional query language statement.

6. The method of claim 1, wherein starting the transaction comprises:
determining whether starting the transaction will result in a conflict;
if so, then resolving the conflict according to a conflict resolution scheme; and
if not, then starting the transaction.

7. The method of claim 1, wherein acquiring the read lock on the row comprises acquiring a read committed view of the row.

8. The method of claim 1, wherein acquiring the write lock on the row comprises acquiring a write lock that will prevent another transaction from accessing the row while the transaction is being processed.

9. The method of claim 1, wherein acquiring the write lock on the row comprises acquiring a write lock that will prevent a non-transacted file system statement from accessing the row while the transaction is being processed.

10. The method of claim 1, wherein acquiring the write lock on the row comprises acquiring a write lock that will prevent another statement within the transaction from writing to the row.

11. The method of claim 1, wherein acquiring the write lock on the row comprises acquiring a write lock that will enable another statement within the transaction to read from the row.

12. The method of claim 1, comprising starting the transaction by acquiring one of a read lock and a write lock on a filestream field of the row.

13. A computer readable medium having computer-executable instructions for performing the steps recited in claim 1.

14. A method for locking and isolation of a file system statement including a call to open an item, a call to read from the item, and a call to close the item, the method comprising:
determining if read access is available for a row of a data table corresponding to the item;
if not, then failing the open; and
if so, then acquiring a read lock on the row.

15. The method of claim 14, comprising determining if read access is available for a row of a data table that includes a user defined type corresponding to the item.

16. The method of claim 14, wherein acquiring the read lock on the row comprises acquiring a read committed view of the row.

17. The method of claim 14, comprising acquiring a read lock on a filestream field of the row.

18. A computer readable medium having computer-executable instructions for performing the steps recited in claim 14.

19. A method for locking and isolation of a file system statement including a call to open an item, a call to write to the item, and a call to close the item, the method comprising:
determining if write access is available for a row of a data table corresponding to the item;
if not, then failing the open; and
if so, then acquiring a write lock on the row.

20. The method of claim 19, comprising determining if write access is available for a row of a data table that includes a user defined type corresponding to the item.

21. The method of claim 19, wherein acquiring the write lock on the row comprises acquiring a write lock that will prevent another statement from accessing the row while the statement is being processed.

22. The method of claim 19, comprising starting the transaction by acquiring a write lock on a filestream field of the row.

23. A computer readable medium having computer-executable instructions for performing the steps recited in claim 19.

24. A system for executing a file system statement in the context of a transaction, the file system statement including a call to open an item, one of a call to read from the item and a call to write to the item, and a call to close the item, the system comprising:
a relational data engine comprising a data table having a row corresponding to the item;
a storage platform built on the relational data engine, the storage platform comprising means for associating the file system statement with the transaction, and means for starting the transaction by acquiring one of a read lock and a write lock on the row.

25. The system of claim 24, wherein the row corresponding to the item includes a user defined type corresponding to the item.

26. The system of claim 24, wherein the storage platform further comprises means for associating a second statement with the transaction.

27. The system of claim 26, wherein the second statement is another file system statement.

28. The system of claim 26, wherein the second statement is a transactional query language statement.

29. The system of claim 24, wherein the means for starting the transaction comprises means for performing the following steps:
determining whether starting the transaction will result in a conflict;
if so, then resolving the conflict according to a conflict resolution scheme; and
if not, then starting the transaction.

30. The system of claim 24, wherein the read lock provides a read committed view of the row.

31. The system of claim 24, wherein the write lock prevents another transaction from accessing the row while the transaction is being processed.

32. The system of claim 24, wherein the write lock prevents a non-transacted file system statement from accessing the row while the transaction is being processed.

33. The system of claim 24, wherein the write lock prevents another statement within the transaction from writing to the row.

34. The system of claim 24, wherein the write lock enables another statement within the transaction to read from the row.

35. The system of claim 24, wherein the row comprises a filestream field.
